(19) United States
(12) Patent Application Publication
(10) Pub. No.: US 2024/0257260 A1
(43) Pub. Date: Aug. 1, 2024

(54) END-TO-END INTEGRATION OF DISPARATE DATA SYSTEMS IN CLAIMS PROCESSING

(71) Applicants: Nicole Blohm, Mount Pleasant, SC (US); Merlyn Evans, Arlington, VA (US); Ashish Patel, Allen, TX (US)

(72) Inventors: Nicole Blohm, Mount Pleasant, SC (US); Merlyn Evans, Arlington, VA (US); Ashish Patel, Allen, TX (US)

(73) Assignee: Ricoh Company, Ltd., Tokyo (JP)

(21) Appl. No.: 18/104,217

(22) Filed: Jan. 31, 2023

(51) Int. Cl. G06Q 40/08

(52) U.S. Cl. CPC G06Q 40/08

(57) ABSTRACT

Techniques for end-to-end Integration of disparate data systems in claims processing are provided. In one technique, in response to receiving first claim data: (1) a first record in a first data source is identified based on the first claim data; (2) a new record, that represents a claim, is generated in a second data source that is different than the first data source; and (3) a first portion of the first claim data is included in the new record. Second claim data that comprises one or more documents is received and the new record is updated with the second claim data. A third record in a third data source that is different than the first and second data sources is identified. A determination may be made whether any more documents are required for the new record. Based on the third record, it determined whether the claim will be fulfilled.

### RELATED APPLICATION DATA

This application is related to U.S. patent application Ser. No. 17/978,970 entitled PROVIDING STRATEGIC RECOMMENDATIONS, LINKS TO ACTIONABLE TASKS, PERFORMANCE PLANNING, AND MEASUREMENTS IN A WORKFLOW, filed Nov. 2, 2022, the contents of which are incorporated by reference in their entirety for all purposes as if fully set forth herein.

### TECHNICAL FIELD

The present disclosure relates generally to computer system integration and, more specifically, to integrating multiple computer systems to provide end-to-end processing of claims.

### BACKGROUND

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

Digitization in the claims management sector has been increasing steadily in the last decade and exponentially in the last few years as people have become accustomed to the convenience and speed of digital processing in other sectors. However, the global pandemic has exposed multiple gaps and flaws in digital claims processes. In some contexts, the percentage of claims that are considered “clean” (i.e., where there is zero or minimal user involvement in order to be processed fully) is less than ten percent. The vast majority of claims require substantial manual intervention to open the claims, process incoming documents associated with the claims, assemble a document packet for each claim, validate all the document information, adjudicate each claim, and fulfill each claim. Such manual involvement is both error prone and requires time.

Causes of “unclean” claims that contribute to delays in processing claims include missing documents, incorrect data (e.g., data in a form does not match in a back-end database), requested claim amounts exceed policy thresholds, out-of-date policies, and policy-specific errors (e.g., different types of policies have different kinds of errors).

Another problem with current claims processing systems is that they are fractured in the sense that different tasks are performed by different parties or entities, which may be third-party vendors or even entities that are considered in-house. Such entities only provide enough information to each other in order to perform their respective tasks and have access to a strict subset of all the relevant databases. There is little to no visibility into the overall claims management process. Additionally, each party or entity have their own service level agreements (SLAs) or expectations when they receive a claim and need to process the claim. A common result is that each party or entity tends to wait the maximum time allowed by the appropriate SLA. Therefore, a series of tasks that could take less than a few days can take weeks, when all the SLA times are added together.

### SUMMARY

The appended claims may serve as a summary. In one aspect, an apparatus is provided. The apparatus comprises a memory storing instructions which, when executed by one or more processors, cause, in response to receiving first claim data, identifying, based on the first claim data, a first record in a first data source, generating a new record (that represents a claim) in a second data source that is different than the first data source, and including a first portion of the first claim data in the new record. Execution of the instructions also causes: after including the first portion in the new record, receiving second claim data that comprises one or more documents; in response to receiving the second claim data, updating the new record with the one or more documents; identifying a third record in a third data source that is different than the first and second data sources; determining, based on the third record and the new record, whether any more documents are required for the new record; after determining that no more documents are required for the new record, determining whether to fulfill the claim.

Another apparatus comprises a memory storing instructions which, when executed by one or more processors, cause: in response to receiving data about a claim, identifying one or more service level agreements that are associated with the claim; identifying a workload of a claims assessor; and based on the one or more service level agreements and the workload of the claims assessor, determining whether to assign the claim to the claims assessor.

The aforementioned approaches may also be implemented by one or more computer-implemented processes and non-transitory computer-readable media that store instructions which, when processed by one or more processed, implement the approach.

### BRIEF DESCRIPTION OF THE DRAWINGS

In the figures of the accompanying drawings like reference numerals refer to similar elements.

FIG. 1 is a flow diagram that depicts a claims management process, in an embodiment;

FIG. 2 is a block diagram that depicts an example claims management system, in an embodiment;

FIG. 3 is screenshot of an example user interface that combines insights with a section for claims management, in an embodiment;

FIG. 4A is a screenshot of an example user interface for displaying details of pending claims, in an embodiment;

FIG. 4B is a screenshot of an example user interface for displaying insights along with details of a claim, in an embodiment;

FIG. 5A is a screenshot of an example user interface that displays insights along with team-level data for a manager, in an embodiment;

FIG. 5B is a screenshot of an example user interface that includes a pop-up window for displaying a workload calculator, in an embodiment;

FIG. 6 is a flow diagram that depicts an example process for processing a claim using an integrated system, in an embodiment;

FIG. 7 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various aspects of the invention are described hereinafter in the following sections:
I. OVERVIEW
II. CLAIMS MANAGEMENT PROCESS
III CLAIMS MANAGEMENT SYSTEM
   A. ORIGINATOR COMPONENT
   B. DOCUMENT INTAKE COMPONENT
   C. PACKET ASSEMBLY COMPONENT
   D. VALIDATION COMPONENT
   E. ADJUDICATION COMPONENT
   F. FULFILLMENT COMPONENT
   G. SECURE DATABASE
   H. EXAMPLE USER INTERFACES
IV. EXAMPLE PROCESS
V. CLAIM ASSIGNMENT
VI. IMPLEMENTATION MECHANISMS

### I. OVERVIEW

An approach is provided for an automated claims management system that integrates multiple data systems and tasks into a single process and provides a single view of multiple claims at different stages in the process. The claims management system is communicatively coupled to (e.g., using one or more APIs) one or more third-party data systems, such as a policy data system, a customer data system, and a claims data system. The claims management system is able to create a view of the data in all three data systems.

### II. CLAIMS MANAGEMENT PROCESS

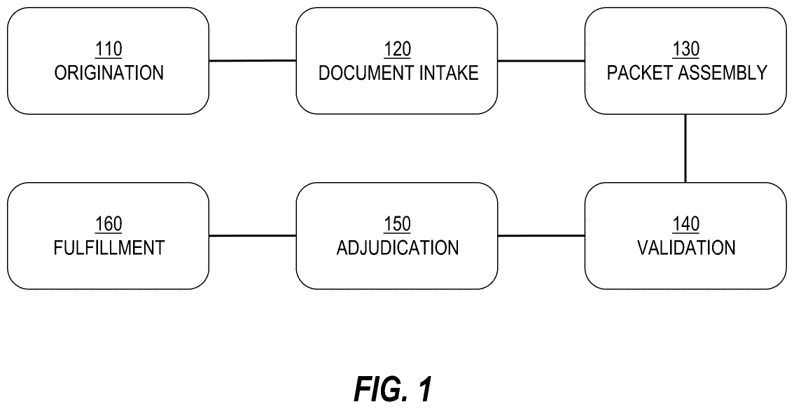

FIG. 1 is a flow diagram that depicts a claims management process 100, in an embodiment. Claims management process 100 includes six processing steps, although there may be more or fewer steps in other embodiments. Also, each step may involve one or more tasks, and each task may comprise multiple sub-tasks. The tasks and sub-tasks vary from claims context to claims context. Example claims contexts include the medical context, the property and casualty (e.g., auto and home) context, and the life and disability context.

The six depicted processing steps include origination 110, document intake 120, packet assembly 130, validation 140, adjudication 150, and fulfillment 160. Origination 110 involves receiving data from a policy holder through one of multiple ways regarding a claim. Example ways through which a claim may originate include:
a. the policy holder submitting a web form through a web page of a website of an enterprise (i.e., the policy providing enterprise) that provides one or more policies to policy holders;
b. the policy holder submitting a claim through a smartphone application provided by the policy providing enterprise;
c. the policy holder submitting a facsimile to a fax machine operated by the policy providing enterprise or a third-party entity that provides claim management process 100;
d. the policy holder submitting one or more physical documents through the postal mail system, arriving at a mail center operated by the policy providing enterprise or the third-party entity; or
e. the policy holder calling a telephone number associated with the policy providing enterprise and a call agent thereof creating an electronic claim through a user interface of the call agent's data system.

Document intake 120 involves receiving and processing documents whose creation is initiated by policy holders, whether the documents come from the policy holders directly or indirectly. For example, a dedicated computer system receives electronic data from web forms through the website or through the smartphone application. As another example, document intake 120 involves scanning documents received through a fax machine and/or through a physical mail service. Scanning documents may involve one or more automated processes, such as optical character recognition (OCR).

Document intake 120 may involve one or more other tasks, such as determining whether a document (whether initially in digital form or converted to a digital form) contains certain information, such as a policy number, a first name, a last name, a mailing address, etc. Certain information may be required to process a document and link the document (or associate it with) the appropriate data record(s) in one or more data systems. Also, different types of documents may have different data requirements. For example, one type of document requires a policy number while another type of document requires a first name, last name, and mailing address. If a document does not contain the required information, then document intake 120 may generate a notification that is sent to the policy holder, such as a notification on a web page that is being presented to the policy holder, an email that includes the policy holder's email address as the destination email address, a text message, or a physical reply mail item.

Packet assembly 130 involves assembling a packet (or group) of documents that are related to a particular claim. Packet assembly 130 involves automatically accessing one or more data systems for each document and identifying one or more records therein. For example, a web form includes a policy holder number and an automated process reads the number, looks up a record in a policy holder database that matches the number, matches information in the web form with information in the retrieved record, creates a new record in a claims database, includes the policy holder number in the new record, creates a new claim identifier and includes the new claim identifier in the new record, and stores information from the web form in the new record. If a document comprises a digital image, then the document may be stored in association with the new (claim) record.

Some packets may require more documents than others. The number and types of documents for each claim may depend on the relevant policy and/or the type of that policy. For example, one auto-related policy may require five documents while another auto-related policy may require six documents, while all life-related policies require just three documents.

A single packet may include documents that are matched to different data systems of the policy providing enterprise. For example, a web form may include a policy holder number and a policy identifier and a matching component uses the policy holder number to identify a first record in a policy holder database and uses the policy identifier to identify a second record in a policy database. If both records are found, then the matching component causes a new record to be created in a claims database, where the new record stores data (e.g., the policy holder number and the policy identifier) that associates the new record with the first and second records.

Validation 140 involves multiple tasks, such as determining whether all documents for a claim pertaining to a particular policy have been received, determining whether data in the documents (e.g., policy identifiers, policy holder numbers, names, addresses) matches corresponding data in records in one or more of the core data systems (such as the policy database, policy holder database, and claims database), determining whether claim request amounts do not exceed policy limits, determining whether a particular policy is out of date, etc. Different policies and different types of policies may have different validation checks.

Adjudication 150 involves one or more tasks to determine whether a claim should be processed fully, partially, or denied altogether. Some governing entities (such as state governments) require licensed individuals to perform such adjudication tasks. Nevertheless, adjudication 150 may involve performing an automatic evaluation of a claim and providing, to a human user, a suggestion based on that evaluation. The human user may view the suggestion along with details of the claim and may accept, decline, or modify the suggestion in order to generate a final adjudication. For example, a task of adjudication 150 may be comparing a repair estimate for a car with the value of the car (e.g., determined automatically by a query to a public database, such as Kelley Blue Book online) where the car is insured by a policy. If the repair estimate is greater than the value of the car, then the automatic evaluation may be to send a check to the policy holder for the value of the car rather than to authorize payment for repair of the car.

Fulfillment 160 involves one or more tasks to communicate with a policy holder. The communication may be a confirmation or a notification that the claim will be fulfilled, partially fulfilled, or declined based on one or more factors. The confirmation/notification may be an email message, a text message, a smartphone application notification, a phone call, and/or a physical mail item. One of the tasks of fulfillment 160 may be electronically sending funds to a financial institution or payment platform associated with the policy holder, such as a bank, Venmo, or Paypal.

In an embodiment, claims management process 100 excludes one or more of these processing steps, such as adjudication 150, which may be performed by an entity that is a third party relative to the policy provider enterprise and to the provider of the claims management system. However, the claims management system may interface with such third party entities by sending and receiving data through secure channels or portals that require authentication and authorization.

### III. CLAIMS MANAGEMENT SYSTEM

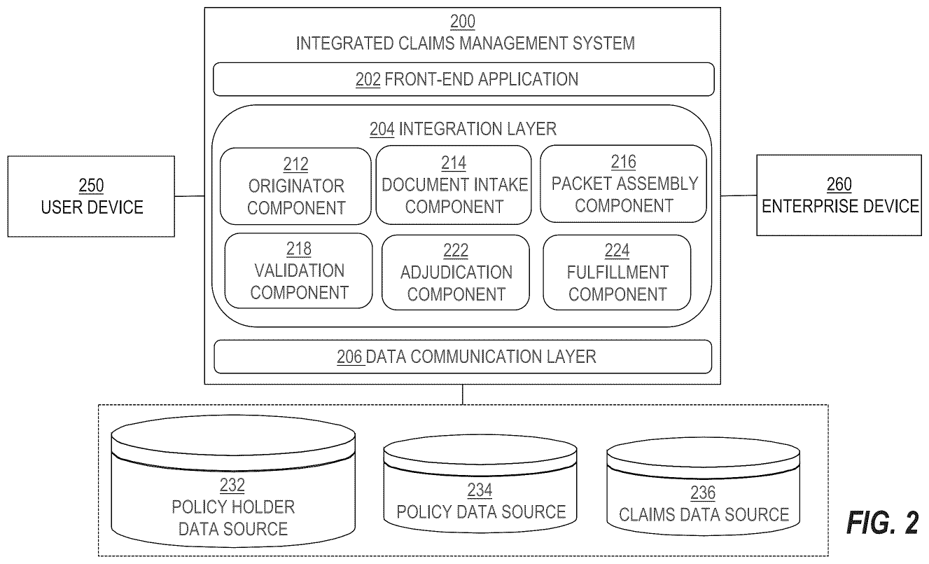

FIG. 2 is a block diagram that depicts an example integrated claims management system 200, in an embodiment. Integrated claims management system 200 includes a front-end application 202, an integration layer 204, and a data layer 206, each of which is implemented in software, hardware, or a combination of software and hardware. Each of these components or elements of integrated claims management system 200 may be implemented on a single computing device or on multiple computing devices that are communicatively coupled to each other. For example, data layer 206 allows components in integration layer 204 to communicate with external data sources 232-236. External data sources 232-236 comprise one or more storage devices that host data pertaining to a particular enterprise and that are separate from one or more computing devices on which integrated claims management system 200 is hosted.

The enterprise that owns the data stored in the external data sources 232-236 may offer one or more main types of policy coverage: property and casualty (e.g., car, home), medical (e.g., health, dental), and life and disability. The enterprise may offer multiple policies of the same type, such as multiple policies that may be used to cover the same vehicle or multiple policies (related to life coverage) that may be used to cover the same person. Different policies may have different premiums, deductibles, and benefits, including benefit limits.

Front-end application 202 receives, from a user device 250, requests for data stored in data layer 206. A user device 250 is a computing device that is communicatively coupled to integrated claims management system 200 over a computer network (not depicted). Examples of a computer network include, without limitation, a Local Area Network (LAN), Wide Area Network (WAN), Ethernet, or the Internet, or one or more terrestrial, satellite or wireless links.

Examples of user device 250 include a laptop computer, a desktop computer, a smartphone, and a wearable device. Front-end application 202 may execute as a web server and the requests may be HTTP requests. (Although only a single user device 250 is depicted, multiple user devices may be communicatively coupled to integrated claims management system 200.) One or more components of integrated claims management system 200 process such requests and either retrieves data through data layer 206 or generates data to be stored in external data sources 232-236 through data layer 206. User device 250 may send, to integrated claims management system 200, data about a new claim, data about an existing claim, or a request for data about an existing claim, such as a status of an existing claim or what documents are needed from the user of user device 250 in order for a final decision to be made about a claim.

Front-end application 202 also receives requests from one or more enterprise devices 260-264 that are communicatively coupled to integrated claims management system 200 over a computer network (e.g., the Internet). Like user device 250, each of enterprise devices 260-264 may be a laptop computer, a desktop computer, a smartphone, or a wearable device. Enterprise devices 260-264 are operated by users of the enterprise that owns the data stored in data layer 206 or provides the policies to end users/customers. Requests from enterprise devices 260-264 may either be to store data in data layer 206 or to retrieve data from data layer 206. Front-end application 202 responds to a request for stored data with data that is rendered by a client application executing on a screen of one of enterprise devices 260-264.

Enterprise devices 260-264 may send, to integrated claims management system 200, requests for data about an individual claim, data about multiple pending claims that have not yet been assigned to a claim assessor, data about multiple pending claims that have been assigned to a particular claim assessor, data about multiple pending claims that have been assigned to different claim assessors of a particular group, or data about multiple past/pending claims pertaining to a single policy holder. Different enterprise users may have different access rights and, thus, are able to make different types of requests.

Types of enterprise users include managers and claim assessors. A manager oversees a group of multiple claim assessors. A claim assessor is an individual person that has authorized access to information about one or more claims that are assigned to the claim assessor. A claims assessor is able to view attributes of each claim that is assigned to the claims assessor, such as the claim's creation date, information about the originator of the claim, a status of the claim (e.g., whether the claim is fulfilled or pending), a listing of documents that are needed to adjudicate the claim, an indication of which of those documents integrated claims management system 200 has already received, an indication of which of those documents have not yet been received, a validation status of each received document, a request amount of the claim, etc. Different types of claims may have different sets of attributes, though some attributes may be common to multiple types of claims.

Integration layer 204 includes an originator component 212, a document intake component 214, a packet assembly component 216, a validation component 218, an adjudication component 222, and a fulfillment component 224, each of which is described in more detail herein.

Data layer 206 is communicatively coupled to at least three external data sources 232-236, which may comprise one or more storage devices, such as disk storage, Flash storage, or other persistent storage. External data sources 232-236 may be in a cloud network or may be on-site of the enterprise that provides the policies. Data layer 206 abstracts the communication between integration layer 204 and external data sources 232-236, thus allowing components in integration layer 204 to be composable, i.e., developed independently of how external data sources are implemented, completely agnostic to communication protocols used by external data sources. Thus, data layer 206 is designed with the details of external data sources 232-236 in mind.

Policy holder data source 232 contains data about multiple policy holders, each of which subscribed to a policy provided by the enterprise that owns or manages the data stored in data layer 206. Each record includes data about a policy holder, such as first and last names, mailing address, phone number(s), names and ages of members of the policy holder's family, names or identifiers of one or more policies to which the policy holder is subscribed, a start date of each subscribed-to policy, an end date of each subscribed-to policy, and indication of whether the policy holder has a pending claim for any of the subscribed-to policies.

The names or identifiers of the subscribed-to policies may be primary keys in policy data source 234, which contains data about multiple policies offered by the enterprise. Each record in policy data source 234 includes a name of the corresponding policy, names of documents that the policy requires in order for a claim under the policy to be processed, one or more policy (or benefit) limits (which vary greatly from one type of claim to another), and one or more states in the policy is lawful to be used.

Claims data source 236 contains data about multiple claims. A claim may have one of multiple statuses, such as recently opened, pending, and closed. The pending status may be one of multiple specific statuses, such as pending documents, pending user validation, pending adjudication, and pending fulfillment. A claim also identifies a policy holder (user) using a unique policy holder identifier. A claim also identifies a policy using a unique policy identifier. A claim may indicate which documents have been received and which documents have not yet been received. Example documents include a form from a policy holder, a form from one or more third-party entities (e.g., an approved car repair shop, a doctor's office, a licensed medical professional), a digital image (e.g., of an insured vehicle or house), a phone record from an enterprise user that interacted directly with the policy holder, and a confirmation email from the policy holder.

### A. Originator Component

Originator component 212 creates a new claim in response to receiving (through front-end application 202) certain data from user device 250 or another computing device. For example, originator component 212 receives data from user device 250, which may be a computing device of a policy holder who is notifying the policy provider of a loss, thus triggering the opening of a claim. The data may be a web form that a policy holder fills out or a standardized email from the policy holder with certain claim details that are sufficient to open a new claim.

As another example, originator component 212 receives data from enterprise device 260 of an enterprise user who represents the policy provider and who is opening a claim on behalf of a policy holder. The enterprise user may have received an email, a facsimile, or a physical document with requisite information for opening a new claim. The enterprise user enters the information into an electronic form and transmits the electronic form to originator component 212.

Regardless of how originator component 212 receives claim data pertaining to a claim, originator component 212 communicates with data layer 206 to verify details of the claim data and open a new claim, if the details are verified as valid. For example, originator component 212 identifies a policy holder identifier and a policy identifier in the received claim data. Originator component 212 determines whether the policy identifier is a valid policy identifier. This may be performed by using the policy identifier to perform a lookup of a record in policy data source 234. If no record contains the policy identifier, then the claim is verified as invalid.

Similarly, originator component 212 determines whether the policy holder identifier is a valid policy holder identifier. This may be performed by using the policy holder identifier to perform a lookup of a record in policy holder data source 232. If no record contains the policy identifier, then the claim is verified as invalid.

Other claims details that may be determined as valid before new claim generation is the claim date (e.g., the claim date is not a date in the future or too far in the past), the first and last names match the first and last names of a policy holder in the corresponding record in policy holder data source 232, a valid amount specified in a claim amount field (e.g., the specified amount consist of numbers only and the specified amount is less than a policy threshold indicated in the corresponding record in policy data source 234), and whether the policy is currently active (or active at the time of the critical date, or date of loss).

In an embodiment, a determination of invalid data in claim data triggers originator component 212 sending a notification that indicates reasons for not opening a new claim. The notification may be sent to the computing device from which the claim data was received, such as user device 250 or enterprise device 260. This notification provides an opportunity for a user (whether a policy holder or a policy provider representative) to be notified of the issue, correct the issue immediately, and resend updated claim data.

If originator component 212 determines that one or more data items within received claim data are valid, then originator component 212 causes a new record to be generated. Such causing may be originator component 212 sending a new record generation request to data layer 206, which creates a new record in claims data source 236 and stores data from the new record generation request into the new record, such as all the relevant claim details in the claim data. (Alternatively, such generation may occur without first originator component 212 receiving an indication that the claim data has been verified as valid.) Thus, data layer 206 translates the new record generation request into a request that claims data source 236 is able to process.

### B. Document Intake Component

Document intake component 214 processes electronic documents. Document intake component 214 may be part of a document intake system that comprises one or more computing devices, such as printers, scanners, fax machines, and/or multi-functional peripherals (MFPs), not depicted. Document intake component 214 accepts electronic data representing digital images, scanned documents, PDF documents, web forms, word processing documents, or other types of electronic data. Such electronic data may originate from user device 250, enterprise device 260, or another computing device. For example, a user of user device 250 make take a picture with a camera that is integrated into user device 250 and cause a digital image thereof to be transmitted (directly or indirectly) to front-end application 202, which, based on the nature of the data or accompanying request, determines to forward the request to document intake component 214. As another example, a user of user device 250 sends an email with one or more attachments that are automatically processed by document intake component 214. As another example, a user of user device 250 (or enterprise device 260) scans a printed document and causes user device 250 (or enterprise device 260) to transmit the scan data to document intake component 214.

Document intake component 214 accepts and processes electronic documents and causes the electronic documents to be stored in association with the appropriate claims. Processing electronic documents may involve performing OCR on a digital image (e.g., a scan of a physical form) to generate text data, which can be used by another component to validate a portion of the text data.

Some electronic documents may pertain to a first claim and other electronic documents may pertain to a second claim. Thus, processing involves associating each electronic document with a claim. Such associating may involve identifying a username, a source email address, a user identifier, a claim number, or any other identifier or combination of data within or accompanying an electronic document. Such identifying information is mapped to a user identifier in policy holder data source 232 and stored in association with that user identifier. For example, document intake component 214 identifies a source email address in an email that includes a photo attachment. Document intake component 214 identifies a unique user identifier that is associated with the source email address and causes the photo attachment to be stored in a record associated with the unique user identifier. Similarly, a claim identifier (or user identifying data, such as a user identifier and/or first and last names) and an associated electronic document may cause a search of records (in claims data source 236) for a record that matches the claim identifier or most (or all) of the user identifying data. Alternatively, instead of document intake component 214 performing the record lookup, document intake component 214 transmits user identifying data (along with one or more electronic documents) to data layer 206, which performs the record lookup and ultimate storing.

In an embodiment, document intake component 214 (or another component of claims management system 200) may receive, for a claim, a document that is unexpected or “extra” based on what is expected for the claim or for claims of the same type. For example, claims of type X may require documents of type A, B, and C. However, a document of type D is submitted and is associated with a claim of type X. Document intake component 214 may still process the document and associate that document with a record for that claim. The document may be labeled as “unexpected” or “extra” and an indication of that label may be presented in a user interface that presents information about the claim. Selection of the label may cause the document to be presented in the user interface.

In an embodiment, document intake component 214 (or another component of claims management system 200) processes duplicates. For example, a policy holder mails in a first notice of loss (FNOL) document and then calls a call representative two days later, which is before the FNOL document has been processed. The call representative assists the policy holder by setting up a new claim in a claims database. When the mail arrives, it is now considered a duplicate. Even though the FNOL document implies it is the first document related to a claim, document intake component 214 first checks the claim database to determine whether a record has already been generated for the claim. If so, then document intake component 214 automatically associates the FNOL document (or a scanned version thereof) with the new record so that the FNOL document does not get lost, while avoiding manual intervention in (a) reviewing the FNOL document and (b) starting a new claim just to manually discover that a claim has already been started.

### C. Packet Assembly Component

Packet assembly component 216 keeps track of which documents have not yet been received for a claim and/or which claims are missing documents. Each claim requires one or more documents before adjudication takes place. Claims associated with one policy type (e.g., car policy) may require more documents than claims associated with another policy type (e.g., medical policy). Further, claims associated with one policy of a policy type may require more documents than claims associated with a different policy of the same policy type.

In an embodiment, packet assembly component 216 selects a pending claim in claims data source 236 to determine whether the pending claim is missing any documents. Each record in claims data source 236 may have a flag or bit that indicates whether there are any missing documents. Additionally or alternatively, a record in claims data source 236 may involve multiple fields, each corresponding to a different required document. If a document field is empty, then it is presumed that the corresponding document is missing. Scanning claims data source 236 for pending claims with missing documents may occur regularly, such as daily or hourly. Alternatively, packet assembly component 216 has access to a document that lists claims with missing documents and updates the list to remove a claim when packet assembly component 216 determines that the claim no longer has missing documents. In this way, a regular scan of claims data source 236 is avoided.

Packet assembly component 216 may notify a claims assessor about one or more claims that are missing at least one document. The notification may be presented through a web application executing on enterprise device 260. Additionally or alternatively, the notification may be an email with details about a claim and which documents are missing for that claim.

In an embodiment, front-end application 202 sends, to packet assembly component 216, a request for claims that are missing documents. The request may include one or more selection criteria, such as claims assigned to a particular claims assessor, claims assigned to a particular group of claims assessors, claims associated with a particular policy, claims associated with a particular policy type, or claims that are missing a certain type of document. The request may be generated in response to front-end application 202 receiving a request from enterprise device 260, which may be a computing device of a claims assessor or a manager of the enterprise. In response to receiving a request, packet assembly component 216 identifies zero or more records in claims data source 236 that indicate that the corresponding claims are missing documents and returns data from those one or more records.

### D. Validation Component

Validation component 218 may perform one or more tasks, such as determining whether all documents for a claim have been received, determining whether data in the documents (e.g., policy identifiers, policy holder numbers, claim identifiers, names, addresses, claim amounts, policy types) matches corresponding data in records in external data sources 232-236 (and, optionally, external data sources of third-party entities), determining whether claim request amounts do not exceed policy limits, determining whether a particular policy is out of date, etc.

Validation component 218 may validate a first document submitted by a policy holder and pertaining to a claim at one time and, later, the policy holder submits a second document, which subsequently validation component 218 validates. Thus, validation of documents pertaining to a claim may occur in different phases over time.

In an embodiment, validation component 218 is the intermediary between components 212-216 and data layer 206. Thus, in this embodiment, only validation component 218 interacts with data layer 206, in which case each of components 212-216 communicates with validation component 218, which interacts with data layer 206 on behalf of components 212-216.

If validation component 218 determines that a claim is ready for adjudication, then validation component 218 may notify adjudication component 222, such as by passing a claim identifier to adjudication component 222, indicating that the claim has been validated.

### E. Adjudication Component

Adjudication component 222 may be triggered in response to a communication (e.g., an API call) from validation component 218. Alternatively, adjudication component 222 regularly scans claims data source 236 for records that indicate that the corresponding claims have been fully validated and are, thus, ready for adjudication.

In one embodiment, adjudication component 222 determines whether a validated claim should be fulfilled, partially fulfilled, or denied. A fulfilled claim is a claim where the requested claim amount is paid out to the corresponding policy holder/claimant. A partially fulfilled claim is one where a portion of the requested claim amount is paid out to the corresponding policy holder.

In another embodiment, adjudication component 222 sends a notification to computing device, such as enterprise device 260 or a computing device of a third-party entity that is responsible for claim adjudication. The notification may contain all the relevant details of a claim (e.g., including a time period for responding to the claim) that may be helpful to a person making the manual decision. In this embodiment, adjudication component 222 may provide a suggestion, based on one or more adjudication criteria, of an adjudication decision (i.e., to fulfill, to partially fulfil, or to deny).

Further, in the embodiment of a human user performing adjudication, the human user may make a selection on his/her computing device, which causes a notification to be sent to adjudication component 222. The notification may indicate one of the three types of adjudication decisions.

In either embodiment (whether a human user is involved or not), adjudication component 222 may store an adjudication result in association with the corresponding claim. This may involve adjudication component 222 sending an update record request to data layer 206, which identifies the appropriate record in claims data source 236 and updates that record to indicate the adjudication decision. At this point, if the adjudication decision is either to fulfil or partially fulfil, then the record may indicate that fulfilment has not yet occurred.

### F. Fulfillment Component

Fulfillment component 224 performs one or more tasks related to fulfillment of a claim. Adjudication component 222 may transmit a notification to fulfillment component 224 about an adjudication decision related to a claim. The notification may include a claim identifier of the claim. In response, fulfillment component 224 identifies the appropriate record in claims data source 236.

One task that fulfillment component 224 may perform is causing a notification to be sent to the policy holder of a claim regarding an adjudication decision with respect to the claim. Additionally or alternatively, fulfillment component 224 causes a notification to be sent to a claims assessor to whom the claim has been assigned. The claims assessor may use the notification to reach out to the policy holder in

A task that fulfillment component 224 performs is causing a claim to be fulfilled, such as causing funds to be transferred from one account (associated with the enterprise providing the policy in question) to an account of the policy holder. This transfer may involve fulfillment component 224 providing two account numbers to one financial institution and instructing that financial institution to transfer funds from one of the two accounts to the other of the two accounts. Embodiments are not limited to how a funds transfer is initiated or completed.

### G. Secure Database

In an embodiment, integrated claims management system 200 includes a secure data source 270 that stores data from one or more of data sources 232-236. For example, secure data source 270 may copy data that is from claims data source 236 so that integrated claims management system 200 does not have to access claims data source 236 each time a request for one or more claims is received from enterprise devices 260-264. Instead, secure data source 270 may be stored locally relative to integrated claims management system 200, whereas data sources 232-236 may be remote relative to integrated claims management system 200.

### H. Example User Interfaces

One goal of embodiments includes allowing enterprise users to view the status of each claim at any stage in a claims management process. The following screenshots of user interfaces (provided by front-end application 202) illustrate a result of implementing this goal.

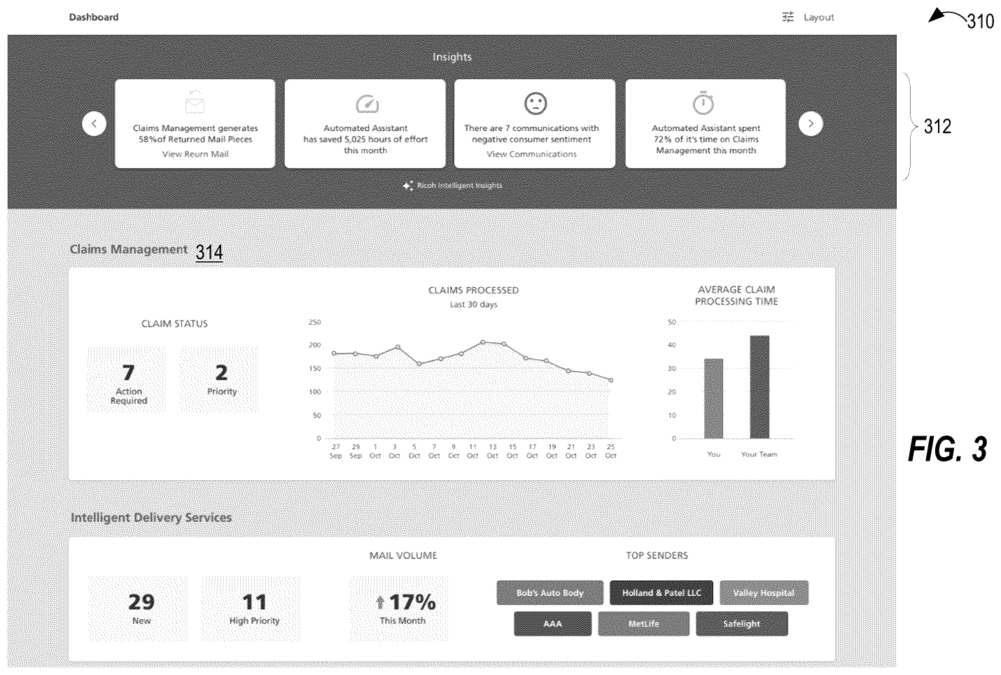

FIG. 3 is screenshot of an example user interface that combines insights 312 with a section 314 for claims management, in an embodiment. User interface 310 is part of a visual dashboard that may be presented to a claims assessor and/or manager of claims assessors operating one of enterprise devices 260-264. In this example, section 314 indicates a first number of claims that require action by a claims assessor, a second number of claims that are considered high priority, a third number of claims that were processed in some manner in each of the last 30 days, an average time it takes for the viewer (e.g., a claims assessor) to process a claim, and an average time it takes for a team (to which the viewer belongs) to process a claim. In order to calculate the average times, each record in claims data source 236 may indicate a start date of the corresponding claim and a date upon which the corresponding policy holder was notified of an adjudication decision regarding the corresponding claim. In order to calculate the third number, each record may include a time stamp if some work was performed on the corresponding claim. In order to calculate the second number, each record corresponding to a pending claim may include a priority flag or field that, if set, indicates that the claim is high priority. In order to calculate the first number, each record corresponding to a pending claim may a series of actions that need to be performed in order for adjudication or fulfillment to occur and whether the next action is one that requires a claim assessor.

Insights 312 that is included in user interface 310 comprises four different insights: a percentage of returned mail that is generated from claims management, a number of worker hours that an automated assistant has saved during a current month, a number of communications with negative consumer sentiment, and an indication of a percentage of time that the automated assistant spent on tasks related to claims management during the current month. The first and second insights include links to view more information about the service or communications in question. For example, selecting the third insight causes the user interface to be updated to display data about at least a subset of the seven communications that have negative consumer sentiment.

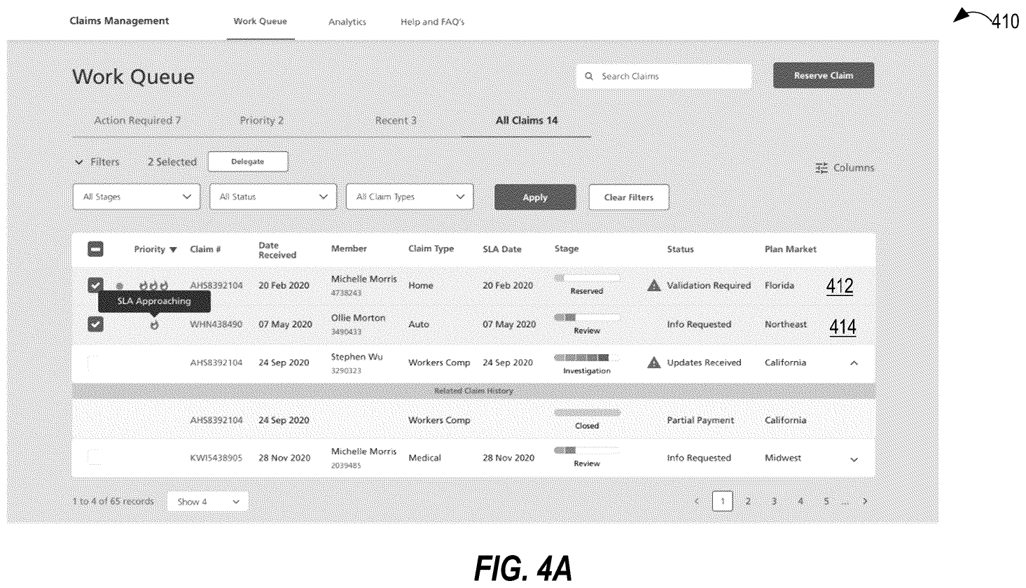

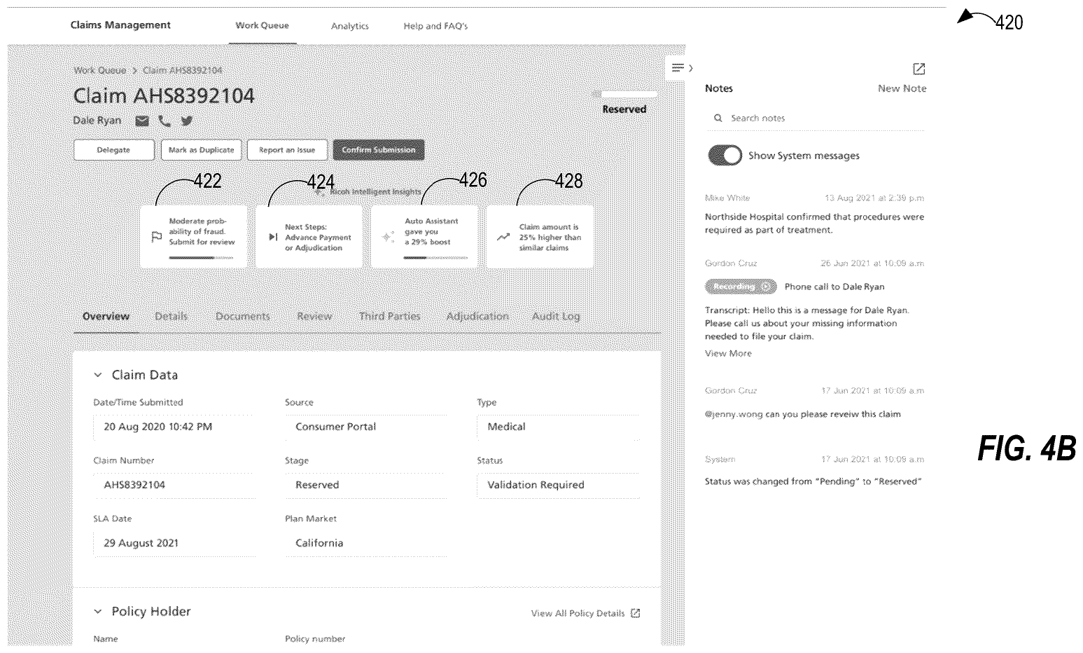

FIG. 4A is a screenshot of an example user interface 410 for displaying details of pending claims, in an embodiment. User interface 410 lists multiple claims and information about each claims, including about claims 412 and 414. User interface 410 may be generated for certain types of users, such as claim assessors or managers. Each claim has a priority rating, a claim number, a date received, a policy holder (or member) name, a claim type, an SLA date, a stage indicator, a status, and a plan market location. As user interface 410 indicates, not only do claims 412-414 have different claim types, claims 412-414 are also assigned to different stages. Additionally, claim 412 has a relatively high priority (with three fire icons) and claim 414 has a lower priority (at least relative to claim 412), as indicated by the one fire icon. Selecting the sole fire icon in claim 414 (or hovering a cursor control pointer over the sole fire icon) causes data about what causes the priority rating to be presented. In this example, an SLA date is approaching for claim 414, indicating that action should be taken on that claim soon.

FIG. 4B is a screenshot of an example user interface 420 for displaying insights along with details of a claim, in an embodiment. User interface 420 may be presented in response to selecting claim 412 in user interface 410. (Thus, user interface 420 may be directed to users having the same access as users of user interface 410.) Such a selection may involve selecting the claim number of claim 414. User interface 420 comprises insights 422-428 along with details of a single claim. Each of insights 422-428 may be selectable graphical elements. The content of one or more of insights 422-428 may have been generated on-the-fly, or in response to selection of claim 412 in user interface 420. Additionally or alternatively, the content of one or more of insights 422-428 may have been generated and stored in association with the selected claim some time prior to user selection of claim 412, such as when details about the claim changed, such as a change in a stage of the claim, a new document is received for the claim, or a day closer to a relevant SLA date.

Insight 422 is an example of predictive data about the selected claim and indicates a probability of fraud. Insight 422 is also associated with an action. User selection of insight 422 causes the claim to be submitted to manual review. This may mean that data about the claim may be placed in a queue that is manually reviewed by one or more human reviewers.

Insight 424 is an example of a particular action to perform relative to the selected claim. User selection of insight 424 may cause the claim to be paid out or adjudicated.

Insights 426-428 are examples of descriptive data that provide more contextual information about the selected claim in relation to other claims. Specifically, insight 426 indicates that an auto assistant tool provided a 29% boost in some metric, such as a reduction in time or worker hours. Insight 428 indicates that the claim amount of the selected claim is 25% higher than similar claims. A similar claim may be claims of the same type (e.g., medical claim, home claim, auto claim) or claims that also share one or more other attributes in common, such as location, square feet of house, make of car, etc.

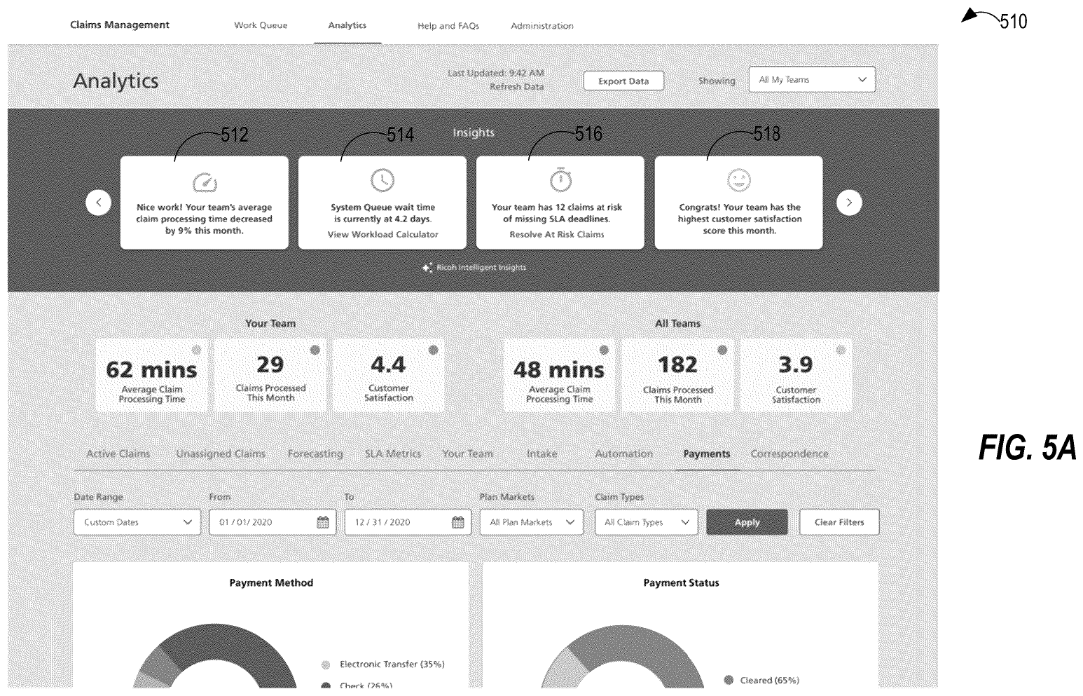

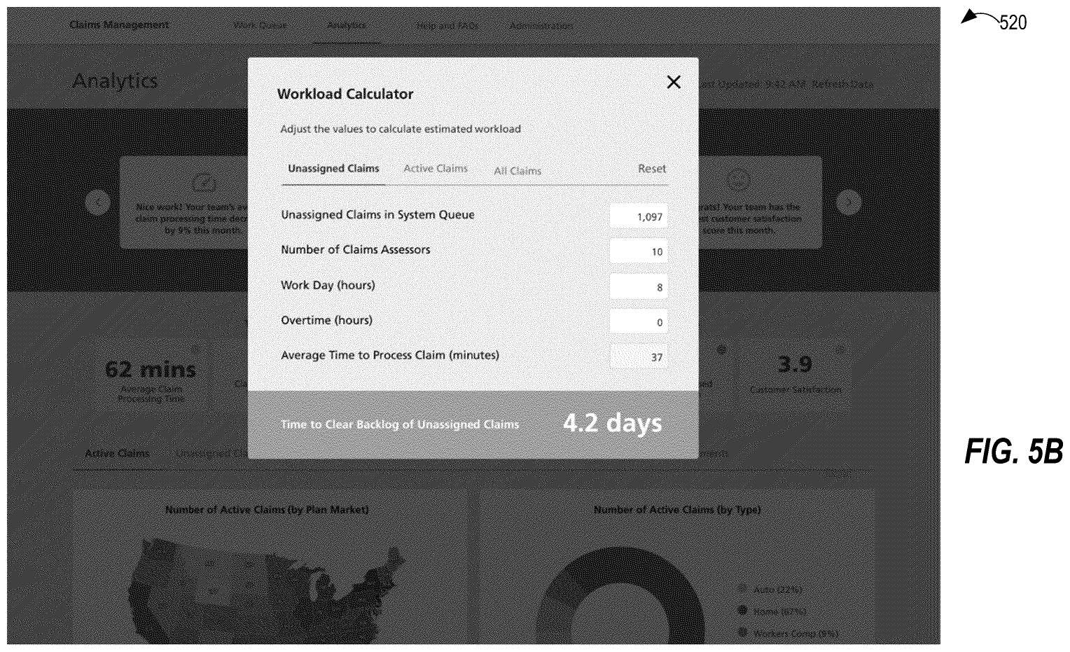

FIG. 5A is a screenshot of an example user interface 510 that displays insights along with team-level data for a manager, in an embodiment. User interface 510 includes insights 512-518, each of which is an example of descriptive data. Insight 512 describes performance of a team relative to the team's performance in the past. Specifically, insight 512 indicates that a team's claim processing time decreased by 9% in the current month relative to the previous month or other time period. Insight 514 indicates a current wait time (i.e., 4.2 days) of items in a queue. Insight 514 includes a link that, when selected, causes a workload calculator to be presented, which is depicted in FIG. 5B.

Insight 516 indicates that the team has twelve claims that are in danger of missing SLA deadlines. User selection of insight 516 may cause user interface 510 to be updated to display those twelve claims. Insight 518 indicates that the team has the highest customer satisfaction score in the current month. User selection of insight 518 may cause user interface 510 to be updated to display the customer satisfaction score along with customer satisfaction scores of other teams and/or breakdown of customer satisfaction scores for individual members of the team.

FIG. 5A also includes first data about a person's team of claim assessors, the data indicating an average claim processing time (i.e., 62 minutes), a number of claims processed so far in the current month, and a customer satisfaction score. FIG. 5A also includes second data that indicates the same type of data as the first data, but about multiple (or all) teams of claims assessors.

FIG. 5B is a screenshot of an example user interface 520 that includes a pop-up window for displaying a workload calculator, in an embodiment. This allows a manager or owner in an enterprise to adjust one or more work-related parameters in order to reduce a backlog in unassigned items, or claims in this example. The work-related parameters include number of unassigned claims in a queue, a number of claim assessors, a number of hours in a work day, a number of hours in overtime, and an average time (in minutes) to process a claim. But adjusting one or more work-related parameter values, a different time to clear the backlog may be calculated. For example, if the number of claim assessors increases to 13, then the 4.2 days may be reduced to a different estimate.

### IV. EXAMPLE PROCESS

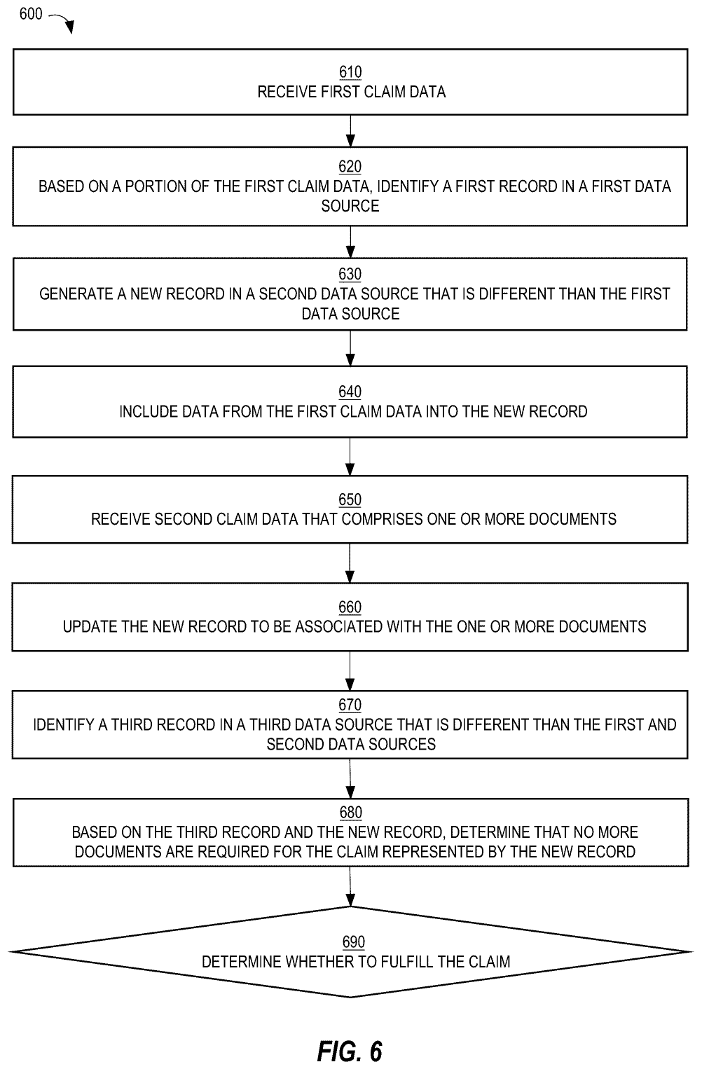

FIG. 6 is a flow diagram that depicts an example process 600 for processing a claim using an integrated system, such as integrated claims management system 200, in an embodiment.

At block 610, first claim data is received. Block 610 may comprise originating component 212 receiving data that originates from user device 250 and/or from enterprise device 260. Block 610 may be performed by front-end application 202 and/or originator component 212.

At block 620, a first record in a first data source is identified based on at least a portion of the first claim data. For example, the portion of the first claim data is a policy holder identifier and the first data source is policy holder data source 232. Block 620 may be performed by originator component 212 or validation component 218.

At block 630, a new record, in a second data source that is different than the first data source, is generated that represents a new claim. The second data source may be claims data source 236. Block 630 may be performed by originator component 212 or validation component 218.

At block 640, data from the first claim data is included in the new record, such as first and last names of the policy holder that originates the first claim data, a claim amount, a date of claim, a policy identifier, and a policy holder identifier. Information from a corresponding record in the policy holder data source and/or a corresponding record in a policy data source may be copied into the new record, such as any relevant policy limits and service level agreements (e.g., stating when adjudication and/or fulfillment are to occur). Block 640 may be performed by originator component 212 or validation component 218.

At block 650, second claim data is received that comprises one or more documents. Block 630 may be performed by front-end application 202 or document intake component 214. The second claim data may be received through a communication channel that is different than the communication channel through which the first claim data was received. For example, the first claim data may be received based on an enterprise representative entering data directly into claims data source 236 based on the enterprise representative receiving claim details over a phone call with the policy holder in question. In contrast, the second claim data may be received by a smartphone application of the policy holder transmitting the second claim data to integrated claims management system 200 over the Internet.

At block 660, the new record is updated to be associated with the one or more documents. Such association may be including the one or more documents in the new record or including, in the new record, one or more references to the one or more documents. Block 660 may be performed by document intake component 214 or validation component 218. For example, before causing the one or more documents to be associated with the new record, validation component 218 determines whether each of the one or more documents contains the necessary information for that document or whether at least one document is missing data or missing valid data. If data is missing or invalid, then validation component 218 may cause a notification to be transmitted to an account or computing device of the policy holder, identifying the policy holder is the missing/invalid data.

At block 670, a third record in a third data source, that is different than the first and second data sources, is identified. The third data source may be policy data source 234; thus, the third record contains information about a policy that pertains to the claim (represented by the new record). Block 670 may be performed by validation component 218.

At block 680, it is determined whether any more documents are required for the new record. This determination may be based on the third record and the new record. For example, if the claim (represented by the new record) requires five documents according to the corresponding policy and the new record is associated with the five required documents and the data in the five required documents has been validated (whether automatically and/or manually). Then the claim is ready for adjudication; otherwise, the claim is not yet ready for adjudication or fulfillment. Block 680 may be performed by validation component 218.

At block 690, after it is determined that no more documents are required for the new record, it is determined whether to fulfill the claim. Block 680 may be performed by adjudication component 222, fulfillment component 224, or both. For example, adjudication component 222 may notify a particular person or entity about the claim in question and wait to receive a response containing an adjudication decision. Depending on the type of adjudication decision, fulfillment component 224 may fulfill the claim or partially fulfill the claim.

While process 600 is depicted and described as being performed in a particular order, embodiments are not so limited. For example, in another embodiment, block 670 is performed before block 660, 650, or 640 and the identified third record is used (e.g., by validation component 218) to validate the first claim data and/or the second claim data.

### V. CLAIM ASSIGNMENT

A claim may be assigned to one of multiple claim assessors. The process of assigning a claim to a claim assessor is referred to as claim assignment. Each claim assessor is associated with one or more attributes, such as skills, licenses, and/or qualifications. For example, a claim assessor is a human user that may be licensed to process claims only from a particular set of states, may have experience with auto-related claims, and speaks English and Spanish. Each claim is associated with one or more requirements (e.g., only someone licensed in a particular state or region; someone familiar with the type of claim) that must be met (or satisfied) by a claim assessor in order for that claim assessor to be assigned to the claim assessor.

In an embodiment, integrated claims management system 200 includes a claims assigning component 226 that assigns each claim to one of multiple claims assessors. (Although depicted separately, claims assigning component 226 may be part of originator component 212.) Claim assignment may be performed once a new claim is created in integrated claims management system 200 or in data layer 206. In a related embodiment, claims assigning component 226 assigns a new claim when there is a sufficient amount of data for the new claim, such as there being data values for certain data fields/items. Additionally, data values in the certain data fields/items may need to be validated or verified (whether against data that is external to system 200 and/or data that is internal to system 200; whether automatically or manually) before claim assignment is performed. Examples of such data fields include a type of claim, a state of the policy holder, a name of the policy holder, and an identifier of an active policy that the policy holder has.

Selecting a claims assessor from among multiple claims assessors may be performed in one of multiple ways. Claims assigning component 226 identifies a set of requirements of a given claim and compares that set of requirements to a set of attributes of a claims assessor. Such a comparison may be performed serially, or one requirement-attribute pair at a time until all relevant requirement-attribute pairs have been considered for a given claims assessor. If any requirement-attribute pair does not match, then the comparison for the given claims assessor may cease and another comparison begins between the set of requirements and a set of attributes of another claims assessor, if one exists. If all relevant requirement-attribute pairs match for a given claims assessor, then the given claims assessor becomes a candidate for the given claim. After all claims assessors are considered for a given claim, a set of zero or more candidates is identified.

In the scenario where the set is greater than one, additional criteria may be applied to select one of the candidates. Example additional criteria include performance criteria and service level agreement (SLA) criteria. Examples of performance criteria include current workload, a historical claim processing rate (e.g., number of claims processed per week or per month), and customer satisfaction score. Current workload may be calculated in one of multiple ways. For example, a current workload may be the number of claims that are assigned to a claims assessor and not yet fulfilled or not yet adjudicated. As another example, claims assigning component 226 (or another component of system 200) generates a current workload score that is based on a number of pending claims that are assigned to claims assessor and that is based on the stage or phase of each pending claim. Thus, claims that are earlier in the claims management pipeline have a higher individual workload score than claims later in the claims management pipeline. The individual workload scores of pending claims currently assigned to a claims assessor may be aggregated (e.g., summed) to generate a total workload score for the claims assessor.

Even though two claims assessors may have the same total workload score, if they have different historical claim processing rates, then claims assigning component 226 may assign a new claim to the claim assessor with a higher claim processing rate, all else being equal.

If two or more candidates are able to process a new claim based on current workloads and historical claim processing rates, then claims assigning component 226 may assign a new claim to the candidate with the highest customer satisfaction score.

In an embodiment, claims assigning component 226 takes into consideration the SLA of a new claim when assigning the new claim to a claims assessor. An SLA may be associated with each stage in a claims management pipeline. Additionally or alternatively, an SLA may be associated with the entire claims management pipeline. For example, based on a first claims assessor's current workload and claims processing rate, a time for the first claims assessor to fully process a new claim is estimated. If that estimated time is greater than the time indicated by an SLA for the new claim, then the new claim is not assigned to the first claims assessor (even though the first claims assessor satisfies the requirements of the new claim), but is assigned to another claims assessor who may even have a lower customer satisfaction score than the first claims assessor. SLAs may vary by claim type and by insurance product type. For example, property & casualty claims may have different SLAs than SLAs of health insurance claims. Also, within property & casualty, SLAs may vary depending on the product (e.g., home, motorcycle, boat) and state in which the policy holder resides.

In an embodiment, as soon as a new claim has been created in data layer 206 (or assigned to a claims assessor), system 200 sends a notification to the policy holder that originated the new claim. The notification may be an email, an automated phone call, a text (SMS) message, or a software application notification.

### VI. IMPLEMENTATION MECHANISMS

According to one embodiment of the invention, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

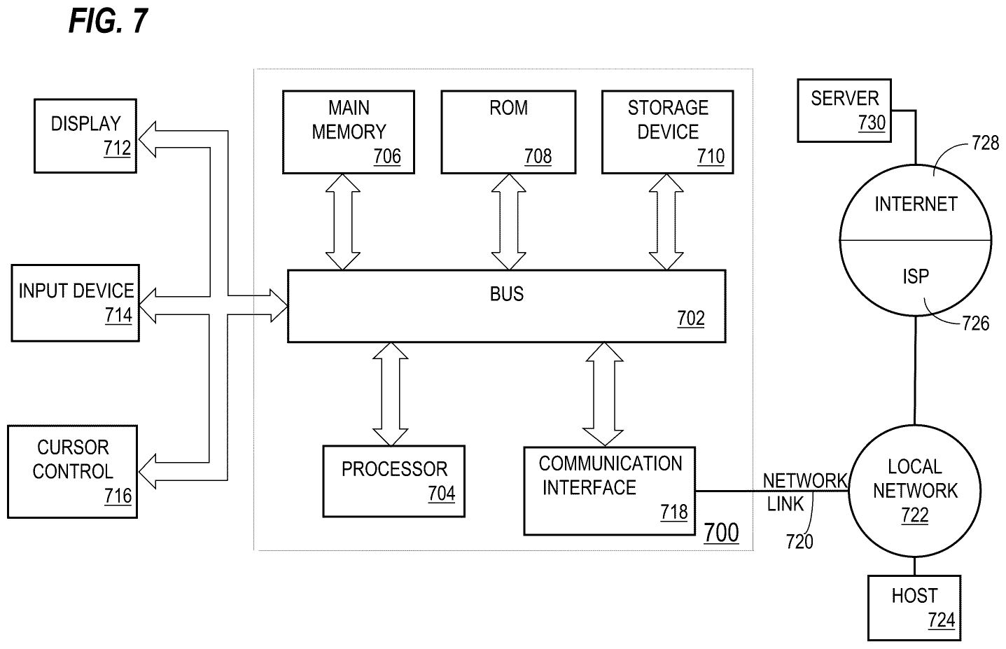

FIG. 7 is a block diagram that depicts an example computer system 700 upon which embodiments of the invention may be implemented. Computer system 700 includes a bus 702 or other communication mechanism for communicating information, and a processor 704 coupled with bus 702 for processing information. Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. Although bus 702 is illustrated as a single bus, bus 702 may comprise one or more buses. For example, bus 702 may include without limitation a control bus by which processor 704 controls other devices within computer system 700, an address bus by which processor 704 specifies memory locations of instructions for execution, or any other type of bus for transferring data or signals between components of computer system 700.

An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic or computer software which, in combination with the computer system, causes or programs computer system 700 to be a special-purpose machine. According to one embodiment of the invention, those techniques are performed by computer system 700 in response to processor 704 executing one or more sequences of one or more instructions contained in main memory 706. Such instructions may be read into main memory 706 from another computer-readable medium, such as storage device 710. Execution of the sequences of instructions contained in main memory 706 causes processor 704 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a computer to operate in a specific manner. In an embodiment implemented using computer system 700, various computer-readable media are involved, for example, in providing instructions to processor 704 for execution. Such a medium may take many forms, including but not limited to, non-volatile media and volatile media. Non-volatile media includes, for example, optical or magnetic disks, such as storage device 710. Volatile media includes dynamic memory, such as main memory 706. Common forms of computer-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or memory cartridge, or any other medium from which a computer can read.

Various forms of computer-readable media may be involved in carrying one or more sequences of one or more instructions to processor 704 for execution. For example, the instructions may initially be carried on a magnetic disk of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718. The received code may be executed by processor 704 as it is received, and/or stored in storage device 710, or other non-volatile storage for later execution.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. An apparatus comprising a memory storing instructions which, when executed by one or more processors, cause:
in response to receiving first claim data:
identifying, based on the first claim data, a first record in a first data source;
generating a new record, that represents a claim, in a second data source that is different than the first data source;
including a first portion of the first claim data in the new record;
after including the first portion in the new record, receiving second claim data that comprises one or more documents;
in response to receiving the second claim data, updating the new record with the one or more documents;
identifying a third record in a third data source that is different than the first and second data sources;
determining, based on the third record and the new record, whether any more documents are required for the new record;
after determining that no more documents are required for the new record, determining whether to fulfill the claim.

2. The apparatus of claim 1, wherein the instructions which, when executed by the one or more processors, further cause:
in response to determining that more documents are required for the new record, storing incomplete data that indicates that a claim represented by the new record is not complete;
causing a message to be transmitted to an account of a user identified in the first record, wherein the message identifies one or more required documents.

3. The apparatus of claim 1, wherein the first claim data includes one or more first documents, wherein including the first portion in the new record comprises including the one or more first documents in the new record.

4. The apparatus of claim 1, wherein the instructions which, when executed by the one or more processors, further cause:
determining whether one or more data items in the first claim data match corresponding one or more data items in the first record.

5. The apparatus of claim 4, wherein the instructions which, when executed by the one or more processors, further cause:
in response to determining that the one or more data items in the first claim data do not match the corresponding one or more data items in the first record, generating mismatch data that identifies the one or more data items;
causing the mismatch data to be presented on a screen of a computing device.

6. The apparatus of claim 1, wherein the instructions which, when executed by the one or more processors, further cause:
based on the third record, identifying a threshold value;
based on one or more of the first claim data or the second claim data, a request amount;
determining whether the request amount exceeds the threshold value;
in response to determining that the request amount exceeds the threshold value, generating exceed data that indicates the request amount;
causing the exceed data to be presented on a screen of a computing device.

7. The apparatus of claim 1, wherein the instructions which, when executed by the one or more processors, further cause, prior to determining whether to fulfill the claim:
generating a recommendation that indicates whether to fulfill the claim;
causing the recommendation and details about the claim to be presented on a screen of a computing device.

8. The apparatus of claim 1, wherein the first claim data and the second claim data are received from a computing device of a user that the first record identifies.

9. The apparatus of claim 1, wherein the instructions, when executed by the one or more processors, further cause:
storing association data that associates the new record with one or more other records, in the second data source, that are associated with a user identified in the first record and that have a status that is one of open, active, completed, or denied.

10. The apparatus of claim 1, wherein the instructions, when executed by the one or more processors, further cause:
in response to receiving third claim data, determining that the third claim data comprises a document that is not an expected document for a claim type that is associated with the new record;
storin the third claim data in association with the new record.

11. An apparatus comprising a memory storing instructions which, when executed by one or more processors, cause:
in response to receiving data about a claim, identifying one or more service level agreements that are associated with the claim;
identifying a workload of a claims assessor;
based on the one or more service level agreements and the workload of the claims assessor, determining whether to assign the claim to the claims assessor.

12. The apparatus of claim 11, wherein the instructions, when executed by the one or more processors, further cause:
determining a claim processing rate of the claims assessor;
wherein determining whether to assign the claim to the claims assessor is also based on the claim processing rate.

13. The apparatus of claim 11, wherein the instructions, when executed by the one or more processors, further cause:
identifying a set of requirements that is associated with the claim and that is different than the one or more service level agreements;
identifying a set of attributes that is associated with the claims assessor and that does not include the workload of the claims assessor;
wherein determining whether to assign the claim to the claims assessor is also based on the set of requirements and the set of attributes.

14. One or more storage media storing instructions which, when executed by one or more processors, cause:
in response to receiving first claim data:
identifying, based on the first claim data, a first record in a first data source;
generating a new record, that represents a claim, in a second data source that is different than the first data source;
including a first portion of the first claim data in the new record;
after including the first portion in the new record, receiving second claim data that comprises one or more documents;
in response to receiving the second claim data, updating the new record with the one or more documents;
identifying a third record in a third data source that is different than the first and second data sources;
based on the third record, determining whether to fulfill the claim.

15. The one or more storage media of claim 14, wherein the instructions which, when executed by the one or more processors, further cause:
in response to determining that more documents are required for the new record, storing incomplete data that indicates that a claim represented by the new record is not complete;
causing a message to be transmitted to an account of a user identified in the first record, wherein the message identifies one or more required documents.

16. The one or more storage media of claim 14, wherein the first claim data includes one or more first documents, wherein including the first portion in the new record comprises including the one or more first documents in the new record.

17. The one or more storage media of claim 14, wherein the instructions which, when executed by the one or more processors, further cause:
determining whether one or more data items in the first claim data match corresponding one or more data items in the first record,
in response to determining that the one or more data items in the first claim data do not match the corresponding one or more data items in the first record, generating mismatch data that identifies the one or more data items;
causing the mismatch data to be presented on a screen of a computing device.

18. The one or more storage media of claim 14, wherein the instructions which, when executed by the one or more processors, further cause:
based on the third record, identifying a threshold value;
based on one or more of the first claim data or the second claim data, a request amount;
determining whether the request amount exceeds the threshold value;
in response to determining that the request amount exceeds the threshold value, generating exceed data that indicates the request amount;
causing the exceed data to be presented on a screen of a computing device.

19. The one or more storage media of claim 14, wherein the instructions which, when executed by the one or more processors, further cause, prior to determining whether to fulfill the claim:
generating a recommendation that indicates whether to fulfill the claim;
causing the recommendation and details about the claim to be presented on a screen of a computing device.

20. The one or more storage media of claim 14, wherein the instructions, when executed by the one or more processors, further cause:
storing association data that associates the new record with one or more other records, in the second data source, that are associated with a user identified in the first record and that have a status that is one of open, active, completed, or denied.
